(19) United States
(12) Patent Application Publication
(10) Pub. No.: US 2003/0163465 A1
(43) Pub. Date: Aug. 28, 2003

(54) Processing information about occurrences of multiple types of events in a consistent manner

(76) Inventor: Daniel Lawrence Morrill, Scotia, NY (US)

Correspondence Address: PERKINS COIE LLP, PATENT-SEA, P.O. BOX 1247, SEATTLE, WA, 98111-1247, US

(21) Appl. No.: 10/086,982

(22) Filed: Feb. 28, 2002

(51) Int. Cl. G06F 17/30; G06F 7/00

(52) U.S. Cl. 707/6

(57) ABSTRACT

A method, system, and computer-readable medium are described for using an event type meta-definition to process occurrence information for multiple defined event types in a consistent manner, such as by using a single data structure to store occurrence information of varying types for multiple defined event types. In some situations, the event type meta-definition is a database metaschema, and if so the single data structure can be a single database table. By using a single data structure, occurrence information for multiple defined event types can be stored and retrieved in a consistent manner, and reports can also be defined to present information for multiple event types in a consistent manner.

### TECHNICAL FIELD

The following disclosure relates generally to processing differing types of information, and more particularly to processing information about different types of defined events in a consistent manner.

### BACKGROUND

Most executing software programs support a variety of types of interaction or usage events, such as various types of interactions with or about users (e.g., logins by users, or modifications of users' access privileges), with or about other software programs (e.g., requests for or supplying of information, or requests by one software program to register with another software program to facilitate future interactions), and/or about various types of data (e.g., receiving data updates of a specified type). The event types supported by a software program may be common to many software programs (e.g., a class or genre of programs) or may instead be specific to that software program. In addition, occurrences of such event types for a software program can result from interactions with another entity (e.g., a user or other software program) that is local to the computing device on which the software program executes or is instead remote from that computing device (e.g., over a network, such as the Internet).

The operators of a software program will typically desire to record and process information about occurrences of at least some of the event types supported by that software program. In order to be able to record and process such information, however, the software program will typically need to be designed to support such activities. In particular, when creating the software program, the creators of the software program will typically define the types of events that will be tracked, and will create data structures and routines specific to those event types to allow specific manners of recording and processing information about occurrences of those event types. During execution of such a software program, the operators can then record and process occurrence information for those previously defined types of events in the previously defined manners.

FIG. 1 illustrates examples of data structures for use with a software program that supports interactions with various users, with the illustrated data structures able to record information about occurrences of three common types of user-related event types. In particular, the creators of this example software program elected to record information about occurrences of creations of user accounts, occurrences of deletions of user accounts, and occurrences of user logins. Accordingly, the creators of the software program defined separate data structures to store information about occurrences of each type of event, which in the illustrated example are database tables 100, 120, and 130 respectively. Each of the tables include various fields (or columns) that represent parameters for the event type, with an occurrence of the event type represented in the table by a record of values for some or all of the parameters. The fields of such a database table along with any defined restrictions on the values for such fields are referred to as a schema for the table, and they define the information that can be stored for occurrences of the event type represented by the table.

Database table 100 is designed to store a variety of information related to occurrences of user account creations, with each row of the table including a record of values that represent a specific user account creation occurrence. In the illustrated embodiment, a user account can be created interactively by a person, and thus the stored information for each occurrence can include various information supplied by that person (e.g., a username, actual name, password, and phone number). The stored information can also include other information that is automatically calculated or retrieved (e.g., a current date/time and a unique identifier (“ID”) to be used to represent the user). Various restrictions may be also be placed on the values stored in the various fields of the record, such as some values being required (e.g., for fields Username and Password), some values being optional (e.g., for field Phone Number), values of some fields being required to be unique among all the records (e.g., for field User ID), etc. In a manner similar to database table 100, database tables 120 and 130 include various information about occurrences of user account deletions and about occurrences of user logins.

When creating separate data structures to represent each event type in the illustrated manner, the types of information to be stored for one event type may differ from the types of information stored for related event types, since the creators of the software program can select the types of information to be stored in any manner that they desire. For example, table 100 stores only a single User ID for each occurrence of a user account creation, while table 120 includes two fields that store user IDs for each occurrence of a user account deletion (i.e., the User ID field 126 representing the user performing the deletion, and the Deleted User ID field 124 representing the user whose account is being deleted). In addition, fields in different tables may have the same name but have values in different formats or with different contextual meanings (e.g., the User ID field 112 in table 100 represents the user whose account is being created, while in table 120 the User ID field 126 represents the user performing the deletion of the account rather than the user whose account is being deleted). Similarly, the Date/Time fields in the various tables could hold values formatted in different manners (e.g., having one field that stores time values with both minutes and seconds, and another field that stores time values with only minutes). In addition to inconsistencies in the information stored in the data structures, each data structure may also have its own defined routines for storing and extracting information from the data structure, with the routines specifying information or otherwise operating in a manner inconsistent with such routines for other data structures.

Unfortunately, storing information about event types in the illustrated manner creates a variety of problems. As noted, various inconsistencies can exist in what information is stored and how it is stored for different event types of a software program, which can cause confusion and difficulties for operators and users of the software program. In addition, the operators of the software program can store occurrence information about an event type only if the creators of the software program defined data structures and corresponding routines for the event type, and moreover can capture values of event type parameters for that event type only if those parameters were selected by the creators of the software program for potential capture. Similarly, if the operators of the software program wish to extract stored information about event type occurrences in order to review such information (e.g., as part of a defined report to be displayed or otherwise presented), the operators may be able to extract and/or provide that information only in the manner defined by the software program creators. Thus, such event type-specific mechanisms for storing and retrieving event type occurrence information create significant restrictions on the ability of operators of the software programs to customize their use of the software programs in ways not anticipated by the creators of the software programs.

In addition to limiting the use of the software programs, such event type-specific mechanisms for storing and retrieving event type occurrence information have other problems as well. For example, the creation of appropriate data structures and the corresponding routines for storing and extracting occurrence information in a useful manner (e.g., via defined report formats) can require significant amounts of time and effort during the software program creation process. Since each data structure and the corresponding routines to support the data structure's use are specific to that event type in that software program, there is little or no opportunity to reuse such data structures and software when creating other software programs, and thus the cost of software development is increased.

Accordingly, it would be beneficial to have a more flexible technique for storing, retrieving and processing occurrence information for various defined event types.

### BRIEF DESCRIPTION OF THE DRAWINGS

FIG. 1 illustrates the use of example database tables specific to various defined types of events to store occurrence information for those event types.

FIGS. 2A-2C illustrate using an example database metaschema to store occurrence information for various defined types of events in a single database table.

FIG. 3 is a block diagram illustrating an embodiment of the disclosed system for using event type meta-definitions to process occurrence information for multiple defined event types in a consistent manner.

FIG. 4 is a flow diagram of an embodiment of the Event Type Definer routine.

FIG. 5 is a flow diagram of an embodiment of the Event Occurrence Information Storer routine.

FIG. 6 is a flow diagram of an embodiment of the Event Occurrence Information Retriever routine.

FIG. 7 is a flow diagram of an embodiment of the Event Occurrence Report Generator routine.

### DETAILED DESCRIPTION

A software facility is described below that uses an event type meta-definition to process occurrence information for multiple defined event types in a consistent manner, such as by using a single data structure to store occurrence information of varying types for multiple defined event types. In some embodiments, the event type meta-definition is a database metaschema, and in those embodiments the single data structure can be a single database table. By using a single data structure, occurrence information for multiple defined event types can be stored and retrieved in a consistent manner, and reports can also be defined to present information for multiple event types in a consistent manner. In addition, in some embodiments the use of the event type meta-definition allows event types to be defined or modified for a software program after its initial creation, such as by operators of the software program in a dynamic fashion. Finally, the data structure and its supporting routines for storing and retrieving occurrence information can in some embodiments be used by multiple software programs, either serially or simultaneously.

For illustrative purposes, some embodiments of the software facility are described below in which occurrence information of varying types is stored in a single database table based on an event type metaschema, and in which occurrence information for various specific event types is stored and/or processed. However, those skilled in the art will appreciate that the techniques of the invention can be used in a wide variety of other situations, and that the invention is not limited to use with databases and/or with the illustrated types of events.

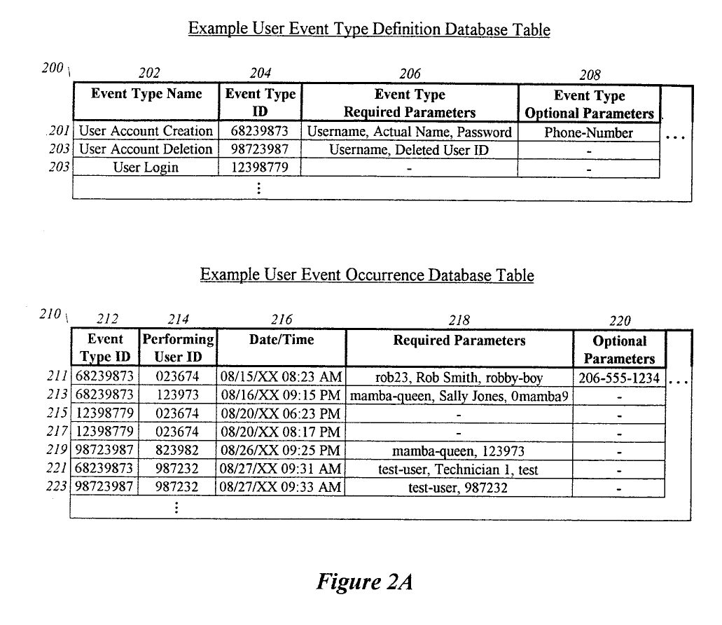

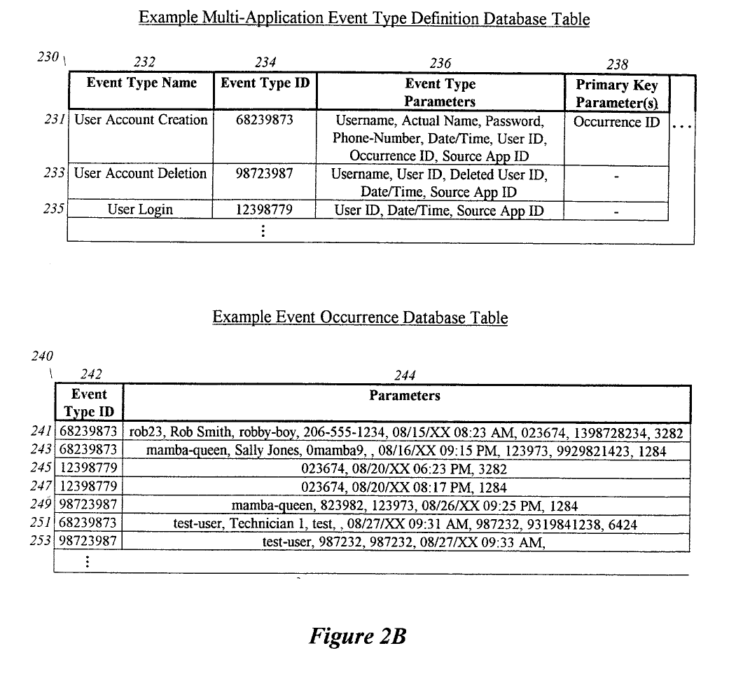

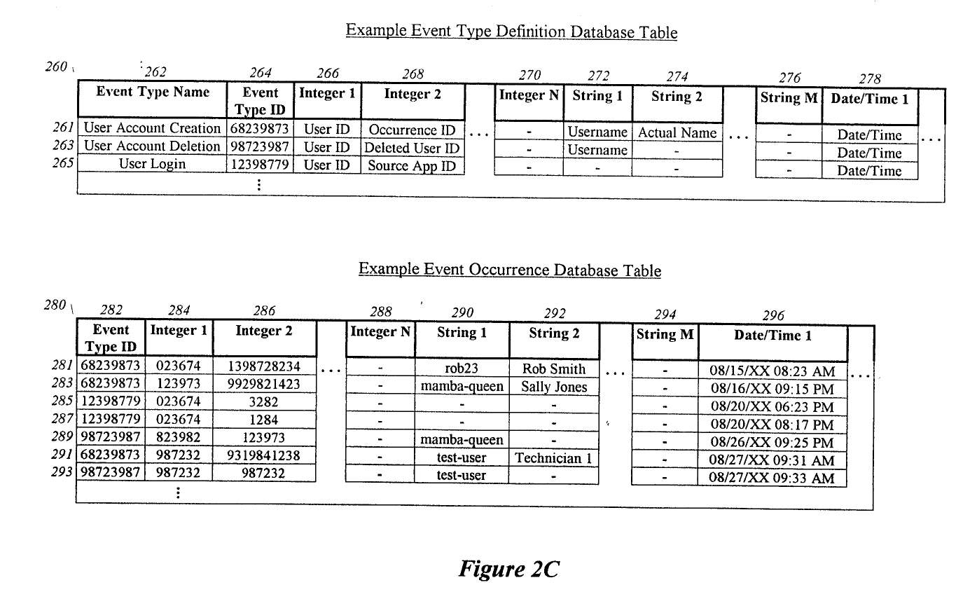

As an illustrative example of the use of an event type metaschema to store occurrence information of varying types for multiple defined event types in a single database table, FIG. 2A illustrates one example of an Event Occurrence database table 210. In the illustrated embodiment, each row of the table represents an occurrence of one of multiple defined event types that each reflect a user interaction with a software program (e.g., with a GUI of a program, such as via a Web page provided by a remote Web server program) or online service. In the illustrated embodiment, fields 212, 214 and 216 of the table represent information that is common to all of the defined event types and is thus stored for all of the occurrences, while fields 218 and 220 represent information that differs based on the defined event type. The stored information that is common to the multiple event types in this illustrated example includes values for a unique Event Type ID field 212 that indicates the type of event, a Performing User ID field 214 that represents the user that performed the event, and a Date/Time field 216 that indicates the time of the occurrence. The Required Parameters field 218 and Optional Parameters field 220 store values for the required and optional parameters of an event type whose occurrence information is being stored, with the number and types of values stored in the fields varying with differing event types.

Since the values present in fields 218 and 220 can vary depending on the type of event which the stored occurrence information represents, the schema for Event Occurrence table 210 is not specific to any particular event type. However, in order to store and extract parameters values in an appropriate manner for different types of events, additional event type definition information is used to indicate the values that may be present in fields 218 and 220 for a particular event type and to assign contextual meaning to those values. This capability to store occurrence information of varying types for multiple defined event types in a single database table by using additional event type definition information provides a metaschema for defining and storing event type information.

In the illustrated embodiment, the additional event type definition information is stored in the Event Type Definition database table 200. Each row of table 200 represents a definition for a type of event and indicates the parameters whose values are to be stored for occurrences of that event type. For example, row 201 of table 200 defines an event type representing creation of a user account, with the Event Type ID field 204 indicating a unique ID that has been assigned to the event type. Fields 206 and 208 of table 200 define the names of the required and optional parameters for the event type. While not illustrated in table 200, in other embodiments additional event type definition information could be included, such as types of values that are allowed for each of the parameters (e.g., integer, string, etc.), restrictions on the values of parameters (e.g., having to be unique among the values for that parameter for all other occurrences of that event type, or having a minimum value), formulas to be used to calculate the values of one or more of the parameters (e.g., based on values for one or more of the other parameters), a sequence in which the parameters values are to be stored in the Event Occurrence table fields (e.g., if different from the listed order of the parameters in fields 206 and 208), indications that some parameters are to be treated as indexes or keys for that event type, etc.

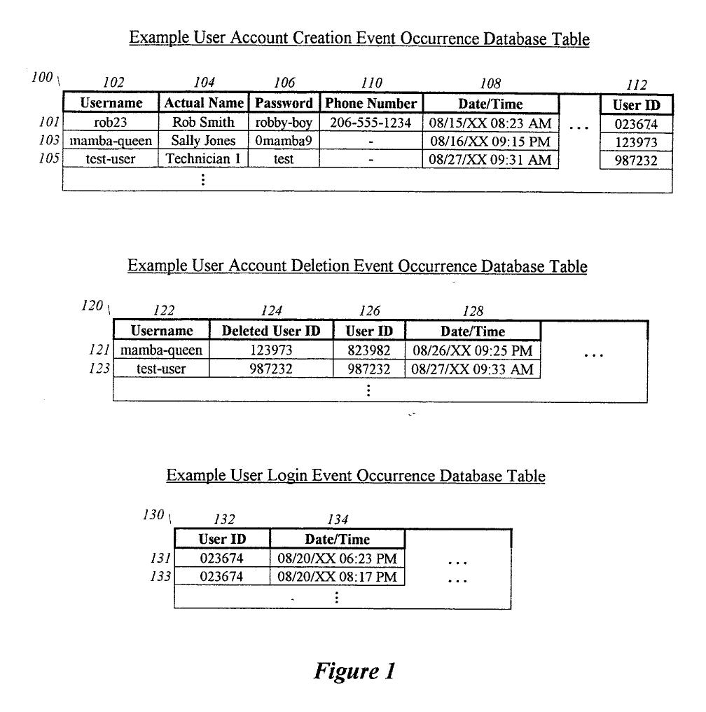

When occurrence information for a user account creation event type is to be stored in the Event Occurrence table, the event type definition information in the Event Type Definition table can be used to determine what event type parameter values are to be stored and the manner in which they are to be stored. For example, row 211 of table 210 represents an occurrence of the User Account Creation event type, as shown by the value of the Event Type ID field 212. Accordingly, the values of fields 218 and 220 correspond to the event type parameters for the event type as defined in row 201 of table 200. In particular, row 211 of table 210 reflects the same occurrence information as was previously illustrated in FIG. 1 for row 101 of table 100. Rows 213-223 of table 210 similarly illustrate the same occurrence information as was shown in FIG. 1 in rows 103 and 105 of table 100, rows 121 and 123 of table 120, and rows 131 and 133 of table 130.

In the illustrated embodiment, the Required Parameters field 218 and Optional Parameters field 220 of table 210 can store varying number of values of varying types of information. In embodiments in which an available database does not support such multi-value fields, the illustrated information in fields 218 and 220 can be stored in other related manners. For example, the information shown could be stored as a single string, with commas (or other delimiters) included within the string to separate the multiple values included within the string. Alternatively, the values of fields 218 and/or 220 could instead be a link to a row in another table, with various such other tables available to support different combinations of types of values.

FIG. 2B illustrates alternative examples of an Event Occurrence database table and a corresponding Event Type Definition database table. In this illustrated example, the Event Occurrence table 240 includes only two fields, with the Event Type ID field 242 identifying the type of event to which the occurrence information in a row corresponds and the Parameters field 244 storing the various parameter values of varying types for that event type. As is shown in the Event Type Definition table 230, event type parameters are not specified as being required or optional in the illustrated embodiment, but one or more of the parameters can instead be designated as a primary key for occurrence information of that event type. If so, the routine that stores information in the Event Occurrence database table 240 and/or the software programs invoking that routine can be used to enforce such restrictions. In addition, in the illustrated embodiment multiple different executing software programs can use the defined event types and can store event type occurrence information together in the Event Occurrence database table 240. Thus, each of the illustrated event type definitions include a Source App ID parameter in the Event Type Parameters field 236 of table 230 so that stored occurrence information for a defined event type can identify which source software program stored the information (e.g., for use in later restricting access to such data to only that program or to authorized users of that program). The Event Type Definition table 230 could additionally store a variety of other types of information for defining event types in other embodiments, such as access or authorization information needed to store and/or retrieve occurrence information in the Event Occurrence table for a defined event type, or definitions for reports or other information presentation formats to be used for occurrence information of a defined event type. By sharing event type information between multiple software programs, a variety of additional functionalities can be provided, such as a single user login for the multiple software programs.

FIG. 2C illustrates yet another example embodiment of an Event Occurrence database table and a corresponding Event Type Definition database table. This illustrated embodiment provides one example of a mechanism for storing occurrence information of varying types for different event types when using a database that does not store multi-value information in single database table fields. In particular, in this illustrated embodiment the Event Type Definition table 260 and the Event Occurrence table 280 each include multiple fields for each of various information types (e.g., integer, string, floating point, etc.), and each event type definition in table 260 indicates which of the parameters for that event type correspond to each of those type-specific fields 266-278. Thus, for example, row 261 of table 260 indicates in fields 272 and 274 that the User Account Creation event type will store string values for parameters Username and Actual Name, but row 263 of the table indicates that the User Account Deletion event type will store only a single string value for parameter Username. When occurrence information for a User Account Creation event type is to be stored in table 280, the string values for the Username and Actual Name parameters will be stored in fields 290 and 292 respectively, as they correspond to fields 272 and 274 of table 260.

Those skilled in the art will appreciate that in some embodiments some of the various illustrated data structure information may not be determined or stored, or may be stored in other associated data structures, while in other embodiments additional information will be included in this data structure or in other associated data structures. For example, some or all of the illustrated Event Occurrence tables could in other embodiments be separated into multiple tables, such as by using event occurrence information tables that each store parameter values of a differing information type. In addition, event type definition information can be specified in a variety of ways other than via a separate Event Type Definition database table.

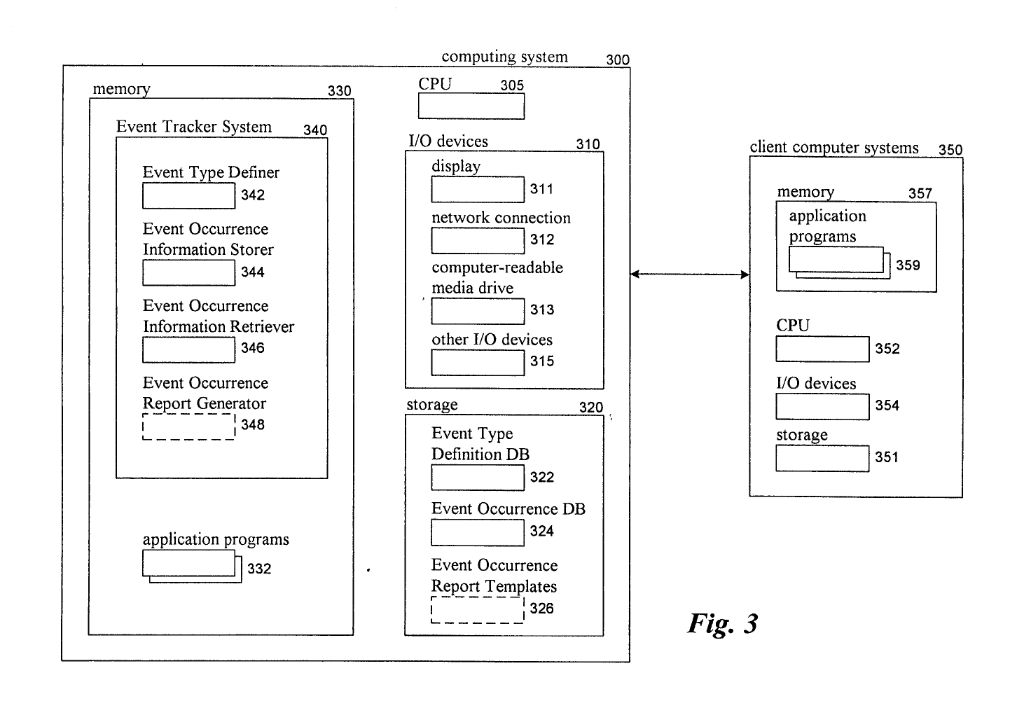

FIG. 3 illustrates a computing system 300 suitable for executing an embodiment of the system facility for using event type meta-definitions to process occurrence information of varying types for multiple defined event type in a consistent manner. The computing system includes a CPU 305, various I/O devices 310, storage 320, and memory 330. The I/O devices include a display 311, a network connection 312, a computer-readable media drive 313, and various other I/O devices 315.

An embodiment of an Event Tracker system 340 is executing in memory, and it includes an Event Type Definer component 342, and Event Occurrence Information Storer component 344, an Event Occurrence Information Retriever component 346, and optionally an Event Occurrence Report Generator component 348. The Event Type Definer component defines event types whose occurrence information is to be stored, such as by creating entries in an appropriate Event Type Definition database table 322 on storage. The Event Occurrence Information Storer component stores occurrence information for defined event types in an Event Occurrence database table 324 on storage. The Event Occurrence Information Retriever component retrieves occurrence information for one or more specified event types from the Event Occurrence database and makes the information available to a requester. When present, the Event Occurrence Report Generator component can use retrieved event occurrence information as part of reports that are generated for presentation or other uses, such as by using optional Event Occurrence Report Templates 326 on storage.

The defined event types and event type occurrence information provided to and used by the Event Tracker system may correspond to one or more software application programs 332 executing in memory on the computing system and/or one or more application programs 359 executing in memory 357 of one or more remote client computer systems 350. In addition, users can access the Event Tracker system in a variety of ways, such as via the I/O devices 310 of computing system 300 if the user has physical access to the computing system. Alternatively, users can use one or more of the client computer systems to remotely access the system (e.g., via the Internet and/or the World Wide Web). Such users may use software or other functionality provided on the client computer systems, such as a browser executing in memory (not shown), to interact with the system and/or with the application programs 332 executing in memory 330. Similarly, the application programs 359 can interact with the Event Tracker system 340 and/or the application programs 332 as appropriate.

Those skilled in the art will appreciate that the Event Tracker system may take other forms in other embodiments. For example, in some embodiments the Event Tracker system may be integrated with a single software program for whom it stores and processes event type occurrence information. Alternatively, the Event Tracker System may store event type occurrence information for multiple executing software programs, but may store the occurrence information and/or the corresponding event type definitions in a separate database table for each such software program.

Those skilled in the art will also appreciate that computing device 300 and computer systems 350 are merely illustrative and are not intended to limit the scope of the present invention. The computing device and/or computer systems may comprise any combination of hardware or software that can perform the described techniques, including computers, network devices, internet appliances, PDAs, wireless phones, pagers, electronic organizers, television-based systems and various other consumer products that include computing and/or storage capabilities. In addition, the computing devices and computer systems may be connected to other devices that are not illustrated, including through one or more networks such as the Internet or via the World Wide Web (WWW). The functionality provided by the illustrated system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

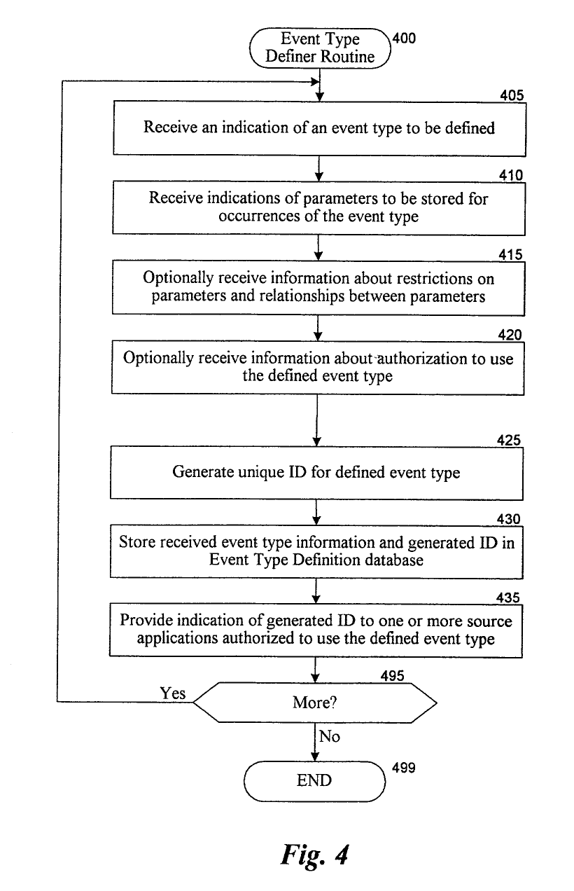

FIG. 4 is a flow diagram of an embodiment of an Event Type Definer routine 400. The routine receives definitions for event types and stores appropriate information to define the event types in the illustrated embodiment in an appropriate Event Type Definition database table. The routine begins at step 405 where an indication is received of an event type to be defined (e.g., a unique name), and in step 410 indications are received of one or more parameters whose values are to be stored for occurrences of the event type. In step 415, information is optionally received about various restrictions on parameter values and/or about relationships between parameter values, such as parameter values that are required or optional, formulas to be used to calculate values of parameters, parameters that are to be treated as primary keys for occurrence information for that event type, etc. In step 420, the routine then optionally receives information about authorization to use the defined event type, such as authorization information for storing occurrence information for that defined event type and/or for retrieving occurrence information for that event type. After receiving the various information about the event type to be defined, the routine continues in step 425 to generate a unique ID for the defined event type. In other embodiments, the unique ID may be supplied as part of the event type definition information, or instead a unique ID may not be assigned to each event type.

In step 430, the routine then stores the received event type information and generated ID in an entry of an Event Type Definition database table, such as a table specific to the requester (e.g., a software program or user that is requesting that the event type be defined) or instead a single table used by multiple software programs. In step 435, the routine then provides an indication of the generated ID to one or more software programs that are authorized to use the defined event type, with the generated ID to be supplied when storing occurrence information of that event type. The authorized programs can be identified in various ways, such as based on explicit indications received as part of the event type definition information (e.g., the optional authorization information), based on previously received requests from software programs for information about defined event types of a specified kind, or by treating only the requester as an authorized program. In other embodiments, the routine could instead publish the event type ID information in a manner accessible to authorized software programs. After step 435, the routine continues to step 495 to determine whether to continue to receive other event type definitions, and if so returns to step 405. If not, the routine continues to step 499 and ends.

Those skilled in the art will appreciate that in other embodiments, this or other routines could additionally be used to modify existing defined event types and/or to delete defined event types. In addition, a variety of additional types of information could be supplied as part of an event type definition, such as indications of times or dates during which the defined event type is valid for use, one or more types of reports to be used when providing occurrence information of this event type, etc.

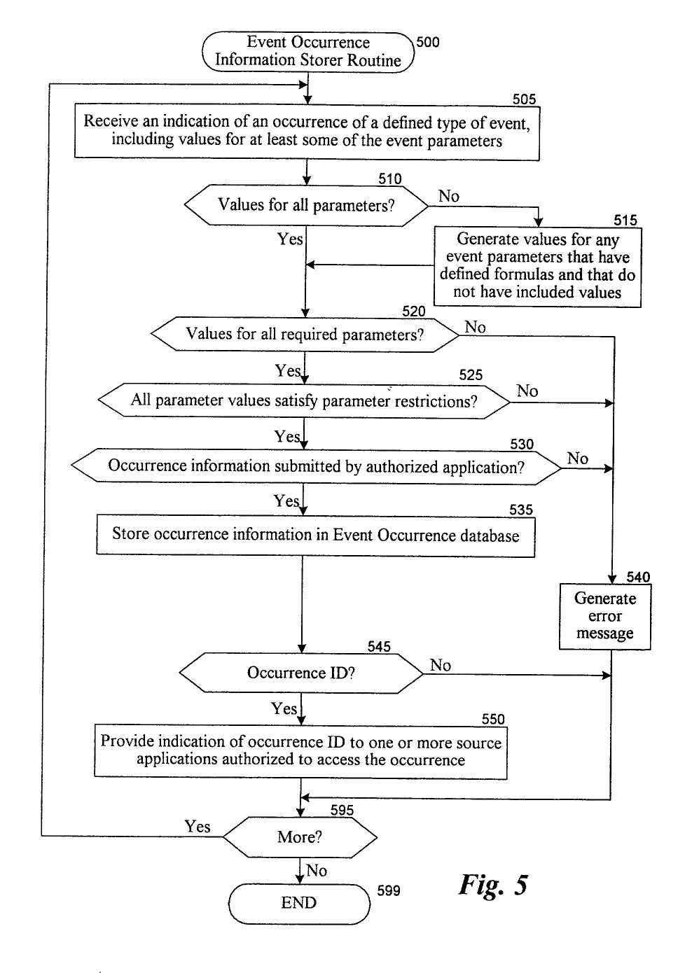

FIG. 5 is a flow diagram of an embodiment of an Event Occurrence Information Storer routine 500. The routine receives indications of occurrence information for defined event types, and stores the occurrence information in the illustrated embodiment in an appropriate Event Occurrence database table. The routine begins at step 505 where an indication is received of occurrence information for a defined type of event that includes an indication of the event type (e.g., a unique Event Type ID) as well as values for at least some of the parameters for the event type. In step 510, the routine determines if values have been received for all event type parameters (e.g., based on the definition of the event type), and if not continues to step 515 to generate values for any parameters for which values were not received and that have a defined method of value generation (e.g., a defined formula). In so doing, the routine may access the event type definition information (e.g., via a corresponding Event Type Definition database table) in order to retrieve such value calculation information. Examples of types of parameters for which values may be generated include an Occurrence ID unique to this occurrence, date/time information for the current time, the unique ID for the software program for which the occurrence information was generated (e.g., if the program can be identified based on the indication received in step 505 and the ID can be determined from an accessible source), etc.

After step 515, or if it was instead determined in step 510 that values were received for all of the event type parameters, the routine continues to step 520 to determine whether values are available for all required parameters (if any). If not, the routine continues to step 540 to generate an error message to be returned to the program or person from which the event type occurrence information was received in step 505. If it is instead determined that values for all required parameters were received in step 520, the routine continues to step 525 to determine if any defined parameter value restrictions are satisfied by the current values, and if not the routine continues to step 540 to generate an error message. In other embodiments, the current values could instead be modified to satisfy the restrictions. If the current values satisfy any defined parameter value restrictions, the routine continues to step 530 to determine if the occurrence information for the event type was supplied by a program or user authorized to store information for this defined event type, and if not the routine continues to step 540.

If the supplier of the occurrence information was authorized, the routine continues to step 535 to store the occurrence information in an Event Occurrence database table, such as a table specific to the supplier of the occurrence information or instead a single table used by multiple software programs. After step 535, the routine continues to step 545 to determine whether an occurrence ID is assigned to this occurrence information and is to be made available (e.g., to the user or routine that submitted the occurrence information in step 505), such as for use in later retrieval of the occurrence information. If so, the routine continues to step 550 to provide an indication of the occurrence ID to one or more software programs that are authorized to access occurrence information for this defined event type, which can be determined in various ways (e.g., the program from which information was received in step 505, from previously supplied authorization information for this defined event type, etc.). After steps 540 or 550, or if it was instead determined in step 545 that there was not an occurrence ID that was to be provided, the routine continues to step 595 to determine whether to continue storing event occurrence information. If so, the routine returns to step 505, and if not continues to step 599 and ends.

Those skilled in the art will appreciate that in other embodiments this or other routines may provide additional functionality to modify existing occurrence information, to remove existing occurrence information, and/or to provide other functionality with respect to such occurrence information (e.g., to log some or all of such information).

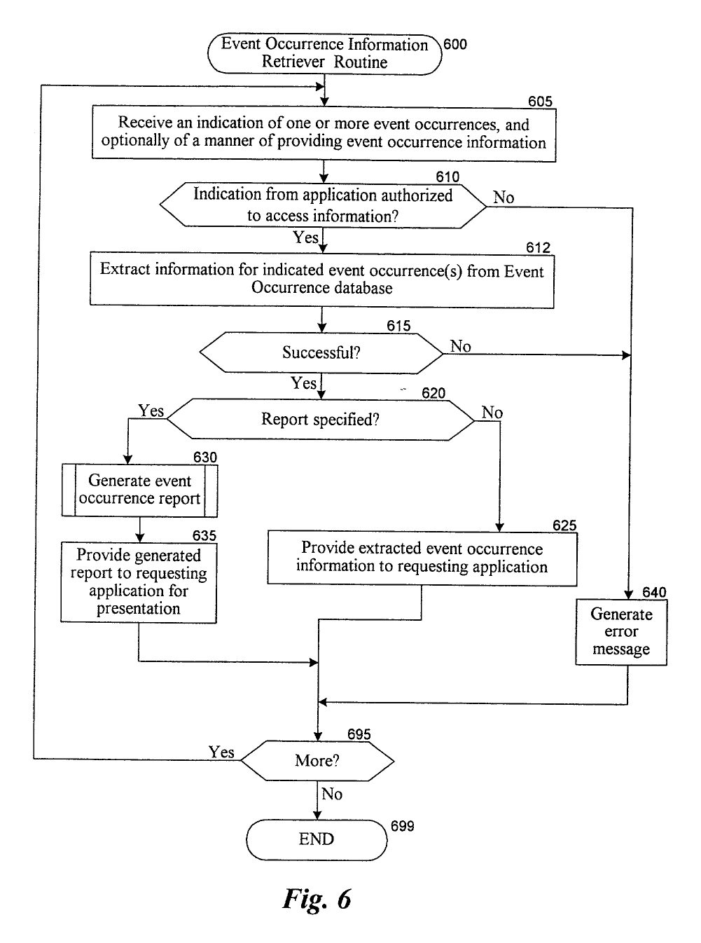

FIG. 6 is a flow diagram of an embodiment of an Event Occurrence Information Retriever routine 600. The routine receives indications to retrieve one or more instances of stored occurrence information for defined event types, and retrieves the information as appropriate. The routine begins at 605 where an indication is received of one or more event type occurrences as well as an optional indication of a manner of providing the retrieved event type occurrence information. The event type occurrences can be specified in various ways, such as via one or more occurrence IDs, search parameters for use when extracting information from a database table (e.g., a date range, one or more event type IDs, one or more IDs for software programs to which the occurrence information corresponds, etc.), and the specification information can be received in a variety of manners (e.g., as a SQL statement for use in extracting information from the Event Occurrence database, via a GUI provided by the routine, etc.). After step 605, the routine continues to step 610 to determine whether the indication is from a user or program who is authorized to access the requested information, and if not the routine continues to step 640 to generate an error message to be returned to the requestor.

If the requestor was authorized, the routine instead continues to step 612 to extract information for the indicated event type occurrences from an appropriate Event Occurrence database table. In step 615, then routine then determines if the information extraction was successful, and if not continues to step 640. If so, the routine instead continues to step 620 to determine whether a specific report is to be used to provide the extracted information, such as a report that was optionally identified in step 605 or a report defined for use with an event type for the extracted occurrence information. A specified report can have a variety of forms, such as a specific layout and formatting of information for display or other presentation to a user. If there is not a specific report to be used, the routine continues to step 625 to provide the extracted event type occurrence information to the requestor in raw format as extracted from the database, unless an event type definition for the occurrence information specifies another format. If a report was specified, the routine instead continues to step 630 to execute a routine to generate the specified event type occurrence report, and supplies the extracted occurrence information to that routine for use with report. After step 630, the routine continues to step 635 to provide the generated report to the requester for presentation or other use. After steps 625, 635, or 640, the routine continues to step 695 to determine whether to continue retrieving event type occurrence information. If so, the routine returns to step 605, and if not the routine continues to step 699 and ends.

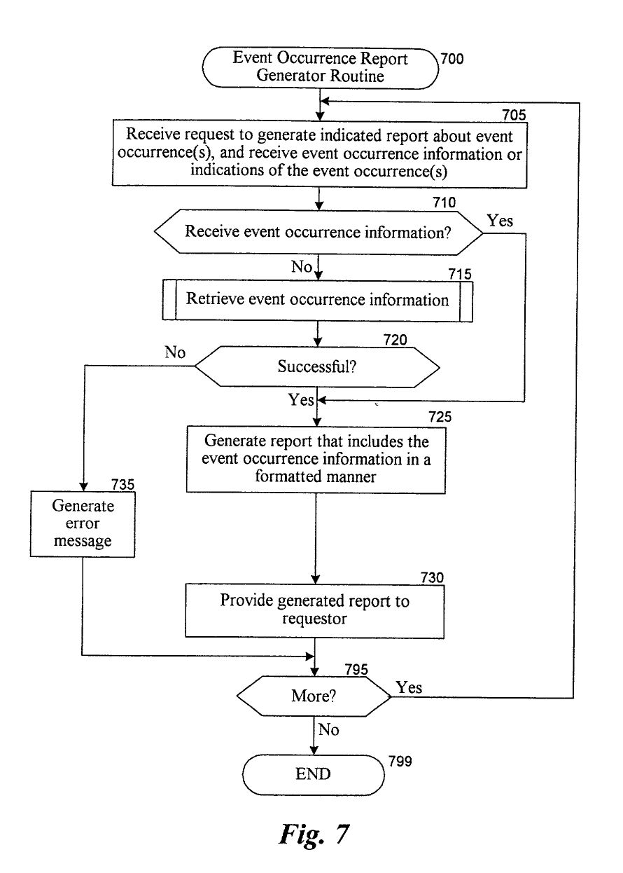

FIG. 7 is a flow diagram of an embodiment of an Event Occurrence Report Generator routine 700. The routine receives an indication of a defined report that is to be generated, and generates and provides the report as appropriate. The routine begins in step 705 where a request is received to generate an indicated report, with the request including either event type occurrence information to be used with the report or instead indications of occurrences whose information is to be used. The routine determines in step 710 whether the actual event type occurrence information to be used was received in step 705, and if not continues to step 715 to execute a routine to retrieve the occurrence information for the indicated occurrences. After step 715, the routine continues to step 720 to determine whether the occurrence information retrieval was successful, and if not continues to step 735 to generate an error message to be returned to the requester. If the occurrence information retrieval was successful, or if it was instead determined in step 710 that the occurrence information to be used was received in step 705, the routine continues to step 725 to generate the specified report with the received or retrieved event type occurrence information, including formatting the occurrence information as needed. In some embodiments, reports may be generated by including occurrence information in a defined template for a report, while in other embodiments formatting instructions may be applied to the occurrence information or a separate report generation routine may be executed for each type of report. After step 725, the routine continues to step 730 to provide the generated report to the requester. After step 730 or 735, the routine continues to step 795 to determine whether to generate additional reports. If so, the routine returns to step 705, and if not the routine continues to step 799 and ends.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A computer-implemented method for storing information about occurrences of multiple distinct types of events in a single database table having multiple defined fields, each of the event types having multiple parameters, the single database table having an associated metaschema that allows multiple event types to be defined in such a manner that information about occurrences of those event types can be stored in the single database table, the method comprising:
receiving definitions for multiple event types having distinct parameters, the received definitions based on the metaschema;
for each of the multiple event type definitions, mapping each of the multiple parameters for that event type to one of the defined fields of the single database table, the mapping of the parameters for the multiple event type definitions based on the metaschema and such that multiple distinct parameters for multiple defined event types are mapped to one of the defined fields of the single database table; and
for each of a plurality of occurrences of the defined event types, storing information about the occurrence of the defined event type in the single database table by,
receiving values for the parameters for the defined event type that reflect the occurrence; and
storing an indication of the event type occurrence in the single database table in such a manner that the stored indication includes a unique identification of the defined event type and that the received value for each parameter is stored in the defined field of the single database table to which that parameter is mapped,
so that information about occurrences of multiple types of events can be stored in a single database table by using an associated metaschema to assist in storing values for multiple distinct parameters of multiple defined event types in one of the defined fields.

2. The method of claim 1 wherein the multiple distinct event type parameters that are mapped to the one defined field of the single database table represent differing types of information.

3. The method of claim 2 wherein the differing types of information include string information and numeric information, such that the values for the multiple distinct event type parameters that are stored in the one defined field include at least one string value and at least one numeric value.

4. The method of claim 1 wherein the multiple distinct event type parameters that are mapped to the one defined field of the single database table represent information of a single type but having differing meanings, such that a value for one of the distinct event type parameters has a meaning that is distinct from a meaning of an identical value for another of the distinct event type parameters.

5. The method of claim 1 including:
receiving an indication of one or more event type occurrences having stored indications in the single database table;
retrieving from the single database table the stored values of at least one of the parameters of each of the indicated event type occurrences; and
providing an indication of the retrieved stored values.

6. The method of claim 5 including receiving an indication of a specified type of report, and wherein the provided indication is a generated report of the specified type that is based at least in part on the retrieved values.

7. The method of claim 5 wherein the indicated event type occurrences includes occurrences of multiple types of events.

8. The method of claim 1 wherein each of the defined event types represents a type of interaction with a software program or online service.

9. The method of claim 8 wherein, for one of the defined event types, the occurrences of that one defined event type reflect interactions with multiple software programs, and wherein the stored indication in the single database table for each of the occurrences of that one defined event type includes a unique identification of the software program that was part of the interaction for that occurrence.

10. The method of claim 1 including storing the definitions for the multiple event types in another database table, the stored definitions each including indications of the mappings of the multiple parameters for the event type being defined to the defined fields of the single database table.

11. A computer-implemented method for storing information about events of multiple types using a single event occurrence data structure, the method comprising:
for each of distinct first and second event types, receiving a definition for the event type that indicates at least one parameter for that event type whose values from occurrences of that event type are to be stored, a first parameter indicated for the first event type being distinct from a second parameter indicated for the second event type;
associating each of the first and second parameters with a single field of the event occurrence data structure;
receiving an indication of an occurrence of the first event type that includes a value of the first parameter for the indicated occurrence;
receiving an indication of an occurrence of the second event type that includes a value of the second parameter for the indicated occurrence; and
using the event occurrence data structure to store indications of each of the occurrences of the first and second event types, the storing of the indications such that the included values of the first and second parameters are each stored as values of the single field.

12. The method of claim 11 wherein the event occurrence data structure has an associated meta-definition, and wherein the associating of the first and second parameters with the single field of the event occurrence data structure is based at least in part on the associated meta-definition.

13. The method of claim 12 wherein the meta-definition includes an element that is associated with the single field of the event occurrence data structure, and wherein the received definitions for the first and second event types indicate that the first and second parameters are each associated with that element of the meta-definition.

14. The method of claim 12 wherein the event occurrence data structure is a database table, and wherein the meta-definition is a metaschema associated with the database table.

15. The method of claim 12 including storing indications of the received definitions in a format specific to the meta-definition.

16. The method of claim 11 including:
receiving one or more indications of one or more event type occurrences having stored indications; and
retrieving in a consistent manner the stored values of the single field for the indicated event type occurrences, the retrieved values including values for the first and second parameters.

17. The method of claim 16 including receiving an indication of a specified type of report, and providing an indication of a generated report of the specified type that is based at least in part on the retrieved values.

18. The method of claim 11 wherein each of the defined event types represents a distinct type of interaction with and/or use of a software program.

19. The method of claim 18 wherein the event types are dynamically defined after creation of the software program.

20. The method of claim 18 wherein the software program is not designed to store indications of the occurrences of at least one of the first and second event types.

21. The method of claim 11 wherein each of the defined event types represents a distinct type of interaction with and/or use of an online service.

22. The method of claim 21 wherein the online service is not designed to store indications of the occurrences of at least one of the first and second event types.

23. The method of claim 11 wherein the received definitions for the first and second event types are from distinct software programs.

24. The method of claim 11 including receiving indications of occurrences of the first event type for each of multiple software programs, and using the event occurrence data structure to store indications of each of the indicated occurrences in such a manner that the received values for the first parameter for each of those occurrences are stored as values of the single field.

25. The method of claim 11 wherein the storing of the information about the events of multiple types is performed as a system service to one or more distinct software programs.

26. The method of claim 11 wherein the values of the first parameter are of a distinct type of information than the values of the second parameter.

27. The method of claim 11 wherein the received definition for the first event type includes one or more specified restrictions on values of the first parameter.

28. The method of claim 27 wherein the storing of the indication of the occurrence of the first event type includes, before storing the value of the first parameter as a value of the single field, verifying that the value of the first parameter satisfies the specified restrictions.

29. The method of claim 11 wherein the received definition for the first event type includes authorization information that restricts use of the first event type.

30. The method of claim 29 wherein the receiving of the indication of the occurrence of the first event type includes receiving authorization information, and wherein the storing of the indication of the occurrence of the first event type includes, before storing the value of the first parameter as a value of the single field, verifying that the received authorization information satisfies the included authorization information.

31. The method of claim 29 including receiving a request for stored information for the indicated occurrence of the first event type, and before supplying the requested stored information, verifying that authorization information received with the request satisfies the included authorization information.

32. The method of claim 11 wherein the storing of the indications of each of the occurrences of the first and second event types includes storing an indication of the event type.

33. The method of claim 32 including determining distinct IDs that are associated with the first and second event types, and wherein the stored indications of the event types are the distinct IDs.

34. The method of claim 11 including receiving definitions for multiple other event types and associating at least one parameter indicated for each of the other event types with the single field of the event occurrence data structure.

35. A computer-readable medium whose contents cause a computing device to store information about events of multiple types using an event occurrence data structure having fields, by performing a method comprising:
receiving definitions for event types, each definition indicating a type of information to be stored for occurrences of that event type;
for each of a plurality of defined event types, receiving an indication of an occurrence of the event type that includes information of the type indicated by the definition for that event type; and
storing indications of each of the occurrences in the event occurrence data structure, the stored indications such that the information included in the received occurrence indications of the types indicated by the definitions for the event types are stored in the same field of the event occurrence data structure.

36. The computer-readable medium of claim 35 wherein the types of information indicated by the event type definitions correspond to differing parameters of those event types, and wherein the included information of the types indicated by the definitions for the event types are parameter values for those parameters.

37. The computer-readable medium of claim 35 wherein the event occurrence data structure has an associated meta-definition, and wherein the method includes associating the types of information indicated by the event type definitions with the same field of the event occurrence data structure based at least in part on the associated meta-definition.

38. The computer-readable medium of claim 35 wherein the computer-readable medium is a memory of a computing device.

39. The computer-readable medium of claim 35 wherein the computer-readable medium is a data transmission medium transmitting a generated data signal containing the contents.

40. The computer-readable medium of claim 35 wherein the contents are instructions that when executed cause the computing device to perform the method.

41. A computing device for storing information about events of multiple types using a single event occurrence data structure, comprising:
an event type definer component that is capable of receiving definitions for each of distinct first and second event types that indicate parameters specific to those event types whose values from occurrences of those event types are to be stored, and of associating each of the indicated parameters with a field of the event occurrence data structure based on a meta-definition associated with the event occurrence data structure, the associating such that a first of the parameters indicated for the first event type and a distinct second of the parameters indicated for the second event type are each associated with a single field of the event occurrence data structure; and
an event occurrence information storer component that is capable of receiving an indication of an occurrence of the first event type that includes values for the parameters indicated for the first event type, of receiving an indication of an occurrence of the second event type that includes values for the parameters indicated for the second event type, and of storing indications of each of the occurrences of the first and second event types in such a manner that the included values for the first and second parameters are each stored as values of the single field.

42. The computing device of claim 41 including an event occurrence information retriever component that is capable of receiving indications of one or more of the event type occurrences having stored indications and of retrieving in a consistent manner the stored values of at least the single field for the indicated event type occurrences.

43. The computing device of claim 41 wherein the values of the first parameter are of a distinct type of information than the values of the second parameter.

44. The computing device of claim 41 wherein the event type definer component and the event occurrence information storer component are executing in memory of the computing device.

45. A computer system for storing information about events of multiple types using a single event occurrence data structure, comprising:
means for receiving definitions for each of distinct first and second event types that indicate at least one type of information to be stored for occurrences of each of the event types, a first type of information indicated for the first event type being distinct from a second type of information indicated for the second event type, and for associating each of the first and second types of information with a single field of the event occurrence data structure;
means for receiving an indication of an occurrence of the first event type that includes information of the first type and receiving an indication of an occurrence of the second event type that includes information of the second type; and
means for using the event occurrence data structure to store indications of each of the occurrences of the first and second event types, the storing of the indications such that the received information of the first and second types are each stored as values of the single field.

46. A computer-implemented method for storing information about events of multiple types using a single event occurrence data structure having multiple fields, the method comprising:
retrieving a meta-definition that specifies how values of distinct parameters for multiple distinct event types can be stored using a single event occurrence data structure;
for each of multiple distinct event types,
receiving a definition for the event type indicating parameters that are specific to the event type and whose values from occurrences of that event type are to be stored; and
mapping the indicated parameters for the event type to the fields of the single event occurrence data structure based on the retrieved meta-definition;
receiving indications of multiple occurrences of the defined event types, each indicated occurrence of an event type including values for the parameters indicated for that event type; and
storing indications of each of the indicated occurrences by, for each of the parameters indicated for the event type whose occurrence is indicated, storing the included value for the parameter from the occurrence in the field of the event occurrence data structure to which the parameter is mapped.

47. The method of claim 46 wherein the retrieved meta-definition is specific to the event occurrence data structure.

48. The method of claim 46 wherein multiple distinct parameters of multiple defined event types are mapped to a single field of the event occurrence data structure.

49. The method of claim 46 wherein multiple distinct parameters whose values are of differing types of information are mapped to a single field of the event occurrence data structure.

50. A computer-implemented method for retrieving stored information about occurrences of multiple defined event types, each of the event types having one or more parameters whose values from occurrences of that event type are stored in one or more of multiple fields of an event occurrence data structure, the method comprising:
receiving an indication of one or more occurrences of one or more of the event types, each indicated occurrence of an event type having one or more values for parameters of that event type that are stored in one or more of the fields of the event occurrence data structure;
retrieving mapping information for each of the one or more event types whose occurrences are indicated the mapping information for an event type indicating fields of the event occurrence data structure that are associated with the parameters of that event type;
for each of the indicated occurrences of an event type, extracting values for at least one of the parameters of that event type for that occurrence from the one or more fields of the event occurrence data structure that are indicated for those parameters by the mapping information for that event type; and
providing an indication of the extracted values.

51. The method of claim 50 wherein one of the fields of the event occurrence data structure stores values for multiple distinct parameters of multiple distinct event types.

52. The method of claim 51 wherein the values of the multiple distinct parameters are of differing types of information.

53. The method of claim 50 wherein the received indications of the occurrences of the event types include indications of one or more parameters of the event types, and wherein the extracting of the values is performed for the indicated parameters.

54. The method of claim 50 wherein the event occurrence data structure has an associated meta-definition, and wherein the retrieved mapping information is based at least in part on the associated meta-definition.

55. The method of claim 54 wherein the event occurrence data structure is a database table, and wherein the meta-definition is a metaschema associated with the database table.

56. The method of claim 50 including receiving an indication of a specified type of report, and wherein the provided indication of the extracted values is a report of the specified type that is based at least in part on the extracted values.

57. A computer-implemented method for reporting about occurrences of multiple defined event types, each of the occurrences having corresponding information stored in an entry of an event occurrence data structure, the method comprising:
receiving an indication of a report to contain information about one or more of the event types;
for each of the one or more event types, determining the entries of the event occurrence data structure that store information about occurrences of those event types;
retrieving from the determined entries at least some of the stored information about the occurrences of the one or more event types;
generating the indicated report based at least in part on the retrieved occurrence information; and
providing an indication of the generated report.

58. The method of claim 57 wherein the received indication of the report specifies one or more occurrences of the one or more event types, and wherein the entries of the event occurrence data structure that are determined store information about the specified occurrences.

59. The method of claim 57 wherein one of the fields of the event occurrence data structure stores values for multiple distinct parameters of multiple distinct event types, and wherein the retrieving of the stored information about the occurrences includes retrieving values of that one field.

60. The method of claim 59 wherein the values of the multiple distinct parameters are of differing types of information.

61. The method of claim 57 wherein the event occurrence data structure has an associated meta-definition, and wherein the determining of the entries and/or the retrieving of the stored information are based at least in part on the associated meta-definition.

62. The method of claim 61 wherein the event occurrence data structure is a database table, and wherein the meta-definition is a metaschema associated with the database table.

63. A method for storing information about occurrences of multiple defined event types using an event occurrence data structure, the method comprising:
for each of a plurality of defined event types,
receiving information reflecting an occurrence of the event type that includes values for one or more parameters specific to that event type;
determining based on a definition for the event type one or more fields of the event occurrence data structure in which the included values of the parameters for that event type are to be stored; and
storing the received information in the event occurrence data structure in such a manner that the included values of the parameters for the event type are stored as values of the determined fields.

64. The method of claim 63 wherein one of the fields of the event occurrence data structure stores values for multiple distinct parameters of multiple distinct event types.

65. The method of claim 64 wherein the values of the multiple distinct parameters are of differing types of information.

66. The method of claim 63 wherein the event occurrence data structure has an associated meta-definition, and wherein the determining of the one or more fields of the event occurrence data structure is based at least in part on the associated meta-definition.

67. The method of claim 66 wherein the event occurrence data structure is a database table, and wherein the meta-definition is a metaschema associated with the database table.

68. A computer-implemented method for processing information about events of multiple types in a consistent manner by using an event type meta-definition, the method comprising:
receiving definitions for multiple distinct event types, each event type having one or more parameters that each receive values for occurrences of that event type;
applying the event type meta-definition to the received definitions so as to associate parameters for multiple event types together, the associated parameters representing different information;
receiving requests to process information about multiple occurrences of the defined event types; and
processing values for the different information represented by the associated parameters from the multiple occurrences of multiple event types in a consistent manner based on the event type meta-definition.

69. The method of claim 68 wherein the values of the associated parameters are of differing types of information.

70. The method of claim 68 wherein the associated parameters are mapped to a single field of an event occurrence data structure such that the values of the associated parameters are all stored as values of the single field.

71. The method of claim 68 wherein the received requests to process information about the multiple occurrences of the defined event types are to store information about the occurrences, and wherein the processing of the values for the different information represented by the associated parameters from the multiple occurrences includes storing those values in such a manner as to be associated together.

72. The method of claim 68 wherein the received requests to process information about the multiple occurrences of the defined event types are to retrieve stored information about the occurrences, and wherein the processing of the values for the different information represented by the associated parameters from the multiple occurrences includes retrieving those stored values in a consistent manner.

73. The method of claim 68 wherein the received requests to process information about the multiple occurrences of the defined event types are to generate one or more reports including information about the occurrences, and wherein the processing of the values for the different information represented by the associated parameters from the multiple occurrences includes generating the one or more reports based on those values in a consistent manner.

74. One or more computer memories collectively containing a data structure that stores information about occurrences of multiple event types, each event type having one or more attributes specific to that event type such that an occurrence of that event type is represented by a group of values for those attributes, the values for the attributes of a first of the event types differing in type of information from the values for the attributes of a second of the event types, the data structure comprising a multiplicity of entries each corresponding to an occurrence of an event type and each having values for at least first and second fields of the data structure, each entry comprising:
a stored value for the first field that uniquely identifies the event type for the occurrence; and
one or more stored values for the second field that are the group of values for the attributes of the identified event type, the one or more stored values obtained from the occurrence,
and wherein the data structure contains an entry corresponding to an occurrence of the first event type and an entry corresponding to an occurrence of the second event type, such that the values stored for the second field differ in the type of information in those data structure entries.

75. The computer memories of claim 74 wherein the data structure is a single database table.

76. The computer memories of claim 74 including a second data structure used to store definitions for the multiple event types in a format specific to a meta-definition for the data structure storing the information about the occurrences, each of the stored event type definitions associating the attributes specific to the event type being defined with the second field of the data structure.

77. The computer memories of claim 74 wherein the values for at least one of the attributes of a first of the event types being of a string type of information and the values for at least one of the attributes of a second of the event types being of a numeric type of information.
